(19) United States
(12) Patent Application Publication
(10) Pub. No.: US 2002/0102519 A1
(43) Pub. Date: Aug. 1, 2002

(54) Dental prostheses fabrication method using pre-contoured impressionable pattern

(76) Inventors: Lloyd Baum, Loma Linda, CA (US); Bruce Walter, Red Lands, CA (US)

Correspondence Address: William G. Lane, Esq., William G. Lane, Inc., P.C., 16485 Laguna Canyon Road, #250, Irvine, CA, 92618, US

(21) Appl. No.: 09/771,465

(22) Filed: Jan. 26, 2001

(51) Int. Cl. A61C 9/00; A61C 13/08

(52) U.S. Cl. 433/214; 264/19

(57) ABSTRACT

A method and article for fabricating gold crown tooth restorations by a novel modification of the lost wax process utilizes mold pattern pre-forms each having a generally cylindrically-shaped base made of material such as wax which is capable of having formed therein and retain an accurate impression of a tooth stump. The pre-form base is surmounted by a hollow cap made of a shape-retaining material such as tin, and a plurality of pre-forms are preferably provided, each having a different exterior shape and size which replicates a tooth of a particular type and size. A pre-form having a shape and size suitable for a particular restoration is selected from the plurality of pre-forms, and the base of the pre-form pressed against a tooth stump to form an impression of the stump in the base, thus converting the preform into a restoration casting pattern for casting a restoration. The pattern is then invested into a semi-liquid slurry of mold material, which is allowed to solidify into a mold. The mold is then heated to a temperature sufficient to melt both the wax base and metal cap of the pattern, the molten materials being evacuated from the mold material through a sprue to form a cavity within the mold. Molten gold alloy is then poured into the mold cavity through the sprue to fabricate a cast gold crown restoration. To enable the mold cavity to be free from oxides and other oxidized metallic compounds from oxidation of the pre-form, an inert atmosphere, such as an argon atmosphere, or vacuum is created inside the burn-out oven during the burn-out or melt-out step. Otherwise, oxidized metallic compounds and other sludge fragments will contaminate the mold cavity and thus ruin the casting.

### BACKGROUND OF THE INVENTION

1. Field of the Invention

The present invention relates to methods and articles used in the fabrication of dental prostheses, i.e., tooth restorations, particularly crowns made of gold and other precious metal alloys. More particularly, the invention relates to a novel method of dental prostheses fabrication in which a tooth restoration is made using a novel composite pattern for investment casting by the lost wax process, the pattern comprising a wax base for receiving a tooth stump impression, and a pre-manufactured metal cap having a desired external shape, including occlusal surface, selected from a plurality of caps which replicate a variety of human teeth types and sizes.

2. Description of Background Art

A widely used dental procedure which is employed to restore functional and cosmetic appearance of a person's mouth after a tooth has become broken or extensively diseased consists of capping the tooth with a prosthetic restoration, typically a crown made of gold alloyed with other precious metals to give the restoration durability and a hardness suitable for chewing foods. The process of fabricating gold crown restorations has been in use for a substantially long time, and includes a well-defined sequence of steps, which are briefly summarized below. A more detailed description can be found in the Dental Laboratory Technology—Fixed Restorative Techniques, Murray, Henry V., et. al., University of North Carolina, Chapel Hill, N.C. (1989), pp. 177-216.

According to existing methods of fabricating gold crown tooth restorations, a mold impression is generally first made of an existing tooth which has decayed or broken portions which warrant capping the tooth with a crown. The impression is made by positioning a tray containing a polymer impression material such as alginate, or a polyether, which is in the form of a slurry or thick paste which rapidly solidifies at ambient room temperature and pressure. After the impression material has solidified, the tray bearing the mold impression is withdrawn from the tooth, a process facilitated by the fact that the solidified mold material is generally in an elastomeric state, allowing it to be peeled away from teeth. Alternatively, a blob of soft wax may be pressed over the existing tooth to form an impression of the tooth in the wax. If an existing crown is to be replaced on a tooth, an impression of the crown is made in the same manner as described above.

After an impression of a tooth or crown has been made, a model is made of the tooth or crown by pouring a modeling material such as plaster of paris into the impression and allowing the modeling material to harden into a stone-like casting.

A next step in currently used methods of fabricating gold crown restorations consists of preparing a diseased or damaged tooth for receiving a new crown. This step entails removing the existing crown, if the tooth had been previously fitted with one, and grinding decayed or broken outer portions of the tooth down until a stump of healthy dentin or enamel remains, a procedure referred to as “prepping” the tooth.

Next, an impression is made of the stump. The stump impression is made somewhat differently than that of the tooth impression as described above. Thus, a wax pre-form of generally cylindrical shape and of a size somewhat larger than the size of a finished crown is positioned longitudinally over the stump, and pressed towards the gum to receive an impression of the stump. The wax pre-form containing the stump impression is then withdrawn from the stump.

The next step in fabricating a gold crown restoration according to presently used methods consists of meticulously sculpting the exterior surface of the wax impression to a desired shape, using the plaster cast model of the tooth or old crown as a guide. In general, the carved exterior surfaces of the wax model cannot simply replicate those of the plaster cast model of the old crown or tooth. This is because the occlusal surface of the restoration, and to a lesser extent, lateral surfaces of the restoration, may require different contouring than corresponding contours of the original tooth or crown, owing to wear on the teeth. Therefore, suitable external contouring of a wax restoration model is a labor-intensive task requiring the skills of a prosthodontist or a skilled, experienced dental lab technician.

After a wax model of a gold crown restoration has been fabricated as described above, the model is used as a pattern to form a cavity in a mold for receiving molten metal used to cast the restoration, using the lost wax process. To fabricate a mold for making a cast metal replica of the pattern, the latter is first pressed into or “invested” into a semi-liquid plaster material which is typically contained in a cylindrically-shaped mold flask. During this process, the inner end of an elongated stem or sprue lead is placed in contact with an outer surface of the pattern, with the outer end of the sprue lead protruding upwardly through the upper surface of the semi-liquid plaster.

Plaster within the mold flask is then allowed to solidify or set at room temperature. The mold is then heated to a temperature sufficient to melt and burn out the pattern and sprue lead, leaving a mold having a hollow interior space or cavity which has the desired shape of a gold crown restoration, and a hollow tubular channel, or sprue, communicating with the mold cavity and forming an entrance opening in an outer surface of the mold. During the burn-out step, melted wax from the pattern flows from the mold cavity through the sprue. Typically, the sprue lead communicates with a frusto conically-shaped depression which penetrates the mold surface. This arrangement results in a funnel-shaped entrance opening or pouring basin being formed in an outer surface of the mold.

After a mold has been prepared as described above, molten gold alloy is poured into the mold cavity through the pouring basin and sprue, moving through the sprue into the mold cavity under the force of gravity, or in response to centrifugal forces produced by spinning the mold. The mold is then allowed to cool, causing the molten gold alloy to solidify into a gold crown restoration which is a replica of the wax tooth model. The mold is then broken to release the gold crown. Metal which solidifies within the sprue and pouring basin and which is connected to the gold crown is referred to as a “button,” and is cut away from the gold crown prior to its installation in the patient's mouth.

The present invention was conceived of to provide an improved method and article for dental prosthesis fabrication, particularly gold crown tooth restorations. According to the present invention, the requirement for skillfully and laboriously carving a wax pattern of a restoration prior to investing the pattern into a semi-liquid plaster mold is eliminated.

### OBJECTS OF THE INVENTION

An object of the present invention is to provide an improved method and article for fabricating gold crown tooth restorations using the lost wax method, in which the step of laboriously and skillfully hand carving a wax model of a tooth to form a mold core pattern is eliminated.

Another object of the invention is to provide a method for fabricating gold crown tooth restorations using the lost wax method, which employs a composite mold pattern pre-form that includes a wax base for receiving an impression of a tooth stump, and a metal cap having a desired exterior tooth shape and size which is selected from a plurality of metal caps which replicate the external shapes of teeth of various types and sizes.

Another object of the invention is to provide a method for fabricating gold crown tooth restorations by the lost wax process, the method including the steps of fabricating a plurality of composite impressionable tooth pattern preforms each having a wax base fitted with a metal shell or cap which replicates a tooth of a particular shape and size, selecting from the plurality of pre-forms one which has a shape approximating that of a desired tooth restoration, impressing into the wax base of the pre-form the stump of a tooth, investing the impressed pre-form into semi-liquid plaster within a mold flask, allowing the semi-liquid plaster to harden, heating the mold sufficiently to melt and remove the wax portion of the pre-form, heating the mold sufficiently to melt and remove the metal shell portion of the pre-form from the mold, and pouring molten metal into the cavity left by the removed wax and metal shell to thereby form a cast metal restoration having an external shape which replicates that of the shell, and a base having an indentation adapted to receive the stump.

Another object of the invention is to provide composite impressionable tooth pattern pre-forms for lost wax casting of dental restorations, each pre-form comprising an impressionable wax base surmounted by a cap made of a shape-retaining material and having a shape and size selected from a plurality of different shapes and sizes corresponding to a variety of tooth shapes and sizes, the cap being made of a material meltable to thereby be evacuable from an investment mold and thereby forming therewithin a cavity continuous with a cavity formed by melting and evacuating the wax base material from the investment mold.

Another object of the invention is to provide composite impressionable tooth pattern pre-forms for lost wax casting of dental restorations, each pre-form comprising an impressionable base made of a moldable material adapted to form therein an impression of a tooth stump, the base being surmounted by a cap made of a shape and size-retaining material and having a shape and size selected from a plurality of different shapes and sizes corresponding to a variety of tooth shapes and sizes, the cap material being phase-changeable from a solid phase to a different phase evacuable from an investment mold to leave a cavity therein having the shape of the cap, and the base material being phase-changeable from a solid phase to a different phase evacuable from an investment mold to leave a cavity therein having the shape of the base, thereby forming in the mold a cavity replicating the composite tooth pattern including a tooth stump impression.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, we do not intend that the scope of our exclusive rights and privileges in the invention be limited to details of the embodiments described. We do intend that equivalents, adaptations and modifications of the invention reasonably inferable from the description contained herein be included within the scope of the invention as defined by the appended claims.

### SUMMARY OF THE INVENTION

Briefly stated, the present invention comprehends an improved method and article for fabricating gold crown tooth restorations by a novel modification of the lost wax process.

According to the present invention, a plurality of mold pattern pre-forms for receiving impressions of tooth stumps are fabricated. Each pre-form has a composite structure which includes a generally cylindrically-shaped base made of a material such as wax which is capable of having formed therein and retain an accurate impression of a tooth stump. The base of each pre-form is surmounted by a hollow cap made of a shape-retaining material such as tin, which may be alloyed with another metal such as silver. According to the invention, each of the plurality of pre-forms has a cap which has a different exterior shape and size which replicates a tooth of a particular type and size.

In accordance with the method of the present invention, a composite preform having an exterior shape and size most closely approximating the desired shape and size of a restoration intended for a particular tooth is selected from the plurality of pre-forms. The base of the selected preform is then longitudinally aligned with the stump of the tooth to be crowned, and pressed longitudinally towards the gum line to thereby form an impression of the stump in the base. The pre-form is then pressed into semi-liquid plaster slurry contained in a mold flask, to invest the shape of the pre-form and the stump impression therein in the plaster. After the plaster has solidified, the mold is heated to a temperature sufficient to melt the wax base, allowing the wax to be poured out of the mold through a sprue channel. The mold is then further heated to the melting temperature of the metal cap, whereupon the molten cap material may also be poured out from the mold through the sprue. This results in a single continuous cavity in the mold comprised of a core part corresponding to the impressed base of the tooth pattern, and a hollow part corresponding to the pre-formed shape of the cap. Molten gold alloy is then poured into the mold cavity through the sprue to cast a gold crown restoration in a conventional manner. Notably, the method and article of the present invention eliminates entirely any requirement for manually sculpting a wax model, a task normally requiring substantial time and skill.

### BRIEF DESCRIPTION OF THE DRAWINGS

FIG. 1 is a front elevation view of a composite impressionable tooth pattern pre-form according to the present invention.

FIG. 2 is an upper plan view of the pre-form of FIG. 1, showing the occlusal surface thereof.

FIG. 3 is a lower plan view of the pre-form of FIG. 1.

FIG. 4 is a rear elevation view of the pre-form of FIG. 1.

FIG. 5 is a fragmentary front perspective view of a dental patient's jaw, showing a first step in a method for fabricating a gold crown tooth restoration according to the present invention, preparatory to making an impression of tooth stump in a wax base portion of the pre-form of FIGS. 1-4.

FIG. 6 is a view similar to that of FIG. 5, but showing the tooth stump impressed into the base within the pre-form, thus forming a finished casting mold pattern.

FIG. 7 is a longitudinal sectional view of the impressed pattern of FIG. 6, showing the pattern invested in plaster contained in a mold flask.

FIG. 8 is a view similar to that of FIG. 7, but showing the mold flask inverted to facilitate migration of gas bubbles within the plaster contained in the flask to migrate upwardly from the plaster.

FIG. 9 is a view similar to that of FIG. 8, but showing a mold sprue stem removed to leave a channel which communicates between the mold cavity and exterior surface of the mold flask.

FIG. 10A is a view similar to that of FIG. 9, but showing the mold heated to the melting temperature of the wax portion of the pattern and the sprue stem, causing both sprue stem and wax portion of the pattern to liquify and flow out of the mold through the sprue.

FIG. 10B is a view similar to that of FIG. 10A, but showing the mold heated to a temperature which causes metal portions of the pattern to liquify and flow out of the mold through the sprue, thereby forming a finished cavity within the mold.

FIG. 11 is a longitudinal sectional view of the mold of FIG. 10, showing the mold inverted preparatory to pouring molten gold alloy into the pouring basin and thence through the sprue into the mold cavity.

FIG. 12 is a longitudinal sectional view of an unfinished gold alloy casting resulting from solidification of the metal alloy introduced into the mold cavity as shown in FIG. 11, after plaster mold material has been broken away from the casting.

FIG. 13 is a full view similar to that of FIG. 11, but showing a “button” portion of the casting which filled the pouring basin and sprue, cut away from the casting.

### DESCRIPTION OF THE PREFERRED EMBODIMENTS

FIGS. 1-13 illustrate novel, pre-contoured impressionable casting mold pattern pre-forms according to the present invention, and novel methods for fabricating cast metal dental prostheses using the pre-forms.

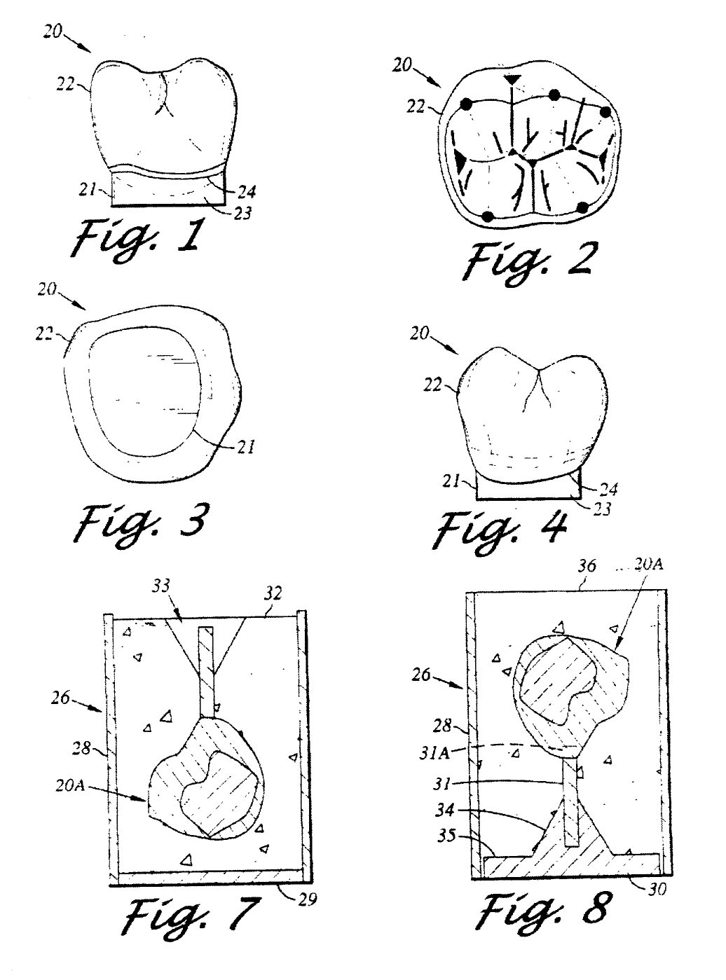

Referring first to FIG. 1 in conjunction with FIGS. 2-4, a casting pattern pre-form 20 according to the present invention may be seen to be a composite structure, including a base 21 having a generally cylindrical shape, surmounted by a cap 22. Base 21 is made of a soft material which is adapted to insertably receive a tooth stump, form an impression of the stump, and retain the impression shape. Materials suitable for this purpose include those which cold-flow and have little elastic memory, such as mineral or polymer clays, or waxes. In a preferred embodiment, base 21 is made of a dental periphery or inlay-type wax having an approximate melting point ranging between 100 and 150 degrees Fahrenheit). Suitable waxes of this type are catalog number 92189 available from the Heragus S. Kulzer Surgical Dental Supply corporation located at 4315 S. Lafayette Blvd., South Bend, Ind. 46614, and Boxing Wax, obtainable from Hygienics Corporation, Akron, Ohio 44310.

Referring still to FIGS. 1-4, i may be seen that hollow cap or shell 22 of composite casting pattern pre-form 20 surmounts and preferably covers a substantially large portion of base 21, leaving a short skirt portion 23 of the base which protrudes below a lower margin 24 of the cap. Cap 22 is made of a relatively durable material which is capable of retaining the shape of various types of teeth, such as molars and pre-molars. In a preferred embodiment, cap 22 is made of tin or a tin alloy consisting of about 90 percent Sn and no more than about 10 percent of another metal such as silver.

As shown in FIGS. 1-4, cap 22 of pre-form 20 preferably has an outer surface which is a substantially accurate replica of a human tooth, e.g., a first premolar. According to the present invention, a plurality of pre-forms 20 are provided, each having a cap replicating a different human tooth. Moreover, each type of pre-form which replicates a particular tooth type is preferably provided in a range of sizes to suit various sizes of patients' mouths. Although the number of tooth types and sizes is a matter of choice for a particular dental professional, a typical set of pre-forms 20 would include about 26 tooth types, both anterior and posterior, each provided in approximately 4 sizes, having a height range of about 5 mm to 15 mm and a girth range of about 9 mm to 30 mm.

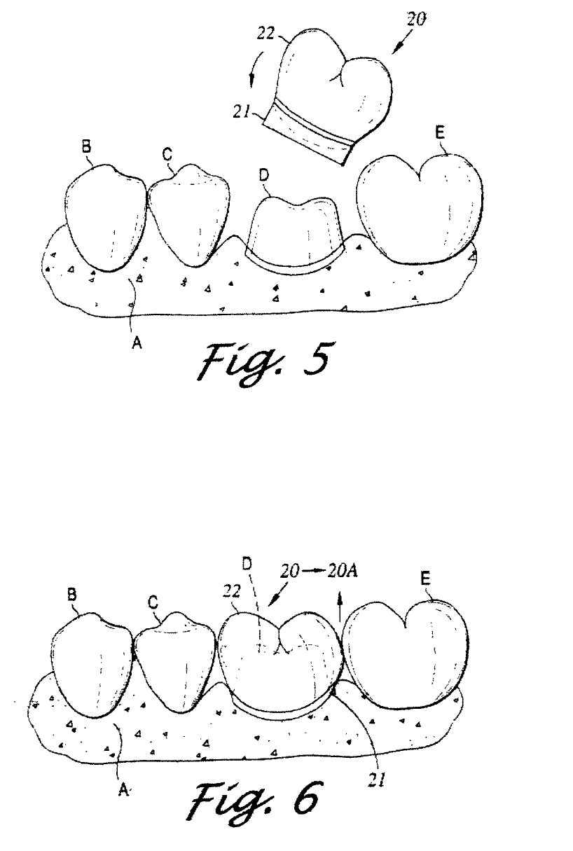

FIGS. 5-13 illustrate an example application of the method of fabricating a cast metal tooth prostheses, specifically, a gold crown, according to the present invention. In the example application of the method according to the present invention, fabrication of a gold crown for a decayed first pre-molar is described, for the sake of specificity. However, those skilled in the art will understand that the methods and articles according to the present invention are not limited in application to any specific tooth type.

Referring now to FIG. 5, a portion A of the jaw of a dental patient is shown to include a lateral incisor B, canine tooth C, decayed first premolar D and second premolar E. As shown in FIG. 5, decayed or otherwise structurally unsound portions of decayed tooth D have been ground away, forming a stump F, in preparation for fitting the tooth with a gold crown restoration. In cases where tooth D has a substantial portion thereof in a condition suitable for replication, an impression may be made of the tooth for casting a plaster model of the tooth, which model may be used as a visual guide in selection of a particular pattern pre-form 20 for a gold crown casting. Also, if decayed tooth D were previously fitted with a crown, an impression can be made of the old crown. In either case, the tooth or crown impression is made using conventional techniques, such as impressing the tooth or crown into a tray containing a semi-liquid molding material, e.g., alginate or polyether, or making a wax impression of the tooth or existing crown.

Referring still to FIG. 5, it may be seen that a first step in fabricating a gold crown tooth restoration according to a method of the present invention consists of selecting a particular composite casting pattern pre-form 20 from a plurality of pre-forms fitted with caps 22 having various shapes and sizes replicating teeth of various shapes and sizes. The selection process can be performed visually, comparing various composite pattern pre-forms with a model of the original tooth or old crown, if available, or by comparing various candidate pre-forms with teeth adjacent to the stump.

FIG. 6 illustrates a second step in the method of fabricating a gold crown tooth restoration according to the present invention. As shown in FIG. 6, this second step includes positioning a composite pattern pre-form 20, selected in step one as described above, in longitudinal alignment with and spaced above stump F of tooth D. Then, as shown in FIG. 6, base 21 of pre-form 20 is pressed downwardly onto stump D, forming an impression of stump F within the wax base and thereby converting the pre-form into a pattern 20A for casting a tooth restoration which has an exterior shape replicating that of cap 22, and a base impression which will conformally receive the stump.

Step 3 of a gold crown fabrication method according to the present invention comprises removing casting pattern 20A bearing an impression of tooth stump F from the stump, and pressing or “investing” the pre-form into a mass of semi-liquid refractory mold material 27, such as plaster of Paris, contained in a mold flask 26. Mold flask 26 includes a cylindrically-shaped metal enclosure 28 which is sealable at one end by a circular disk-shaped base cover 29, and at the opposite end by a circular disk-shaped pattern support member 30 which communicates with pattern 20A via a sprue lead 31. As part of the investment step, sprue lead 31, typically a longitudinally elongated cylinder is made of a low-melting temperature polymer, such as wax, is inserted into the semi-liquid mold material 27. Sprue lead 31 contacts both casting pattern 20A and a first transverse end surface 32 of mold material 27. Preferably, an inner end of sprue lead 31 is inserted into a small hole 31A formed through cap 22. As shown in FIG. 7, a generally conically-shaped pouring basin 33 is preferably formed in surface 32 of mold material 27, the pouring basin being concentrically continuous with sprue lead 31. Pouring basin 28 is conveniently formed in mold material 27 by a conically-shaped boss 34 which protrudes axially inwardly from the inner transverse surface 35 of pattern support member 30, the boss being coaxial with the support member.

After pattern 20A has been inserted into mold material as shown in FIG. 7 and described above, mold flask 26 is inverted, as shown in FIG. 8, and base cover 29 removed. As shown in FIG. 8, pattern 20A is positioned relatively close to surface 36 of mold material 27. This arrangement facilitates migration of gas bubbles upwardly through semi-liquid plaster 27 and outwardly through upper transverse surface 36 of the plaster, a process which may be facilitated by placing the mold flask in a vacuum chamber, and/or vibrating the mold flask.

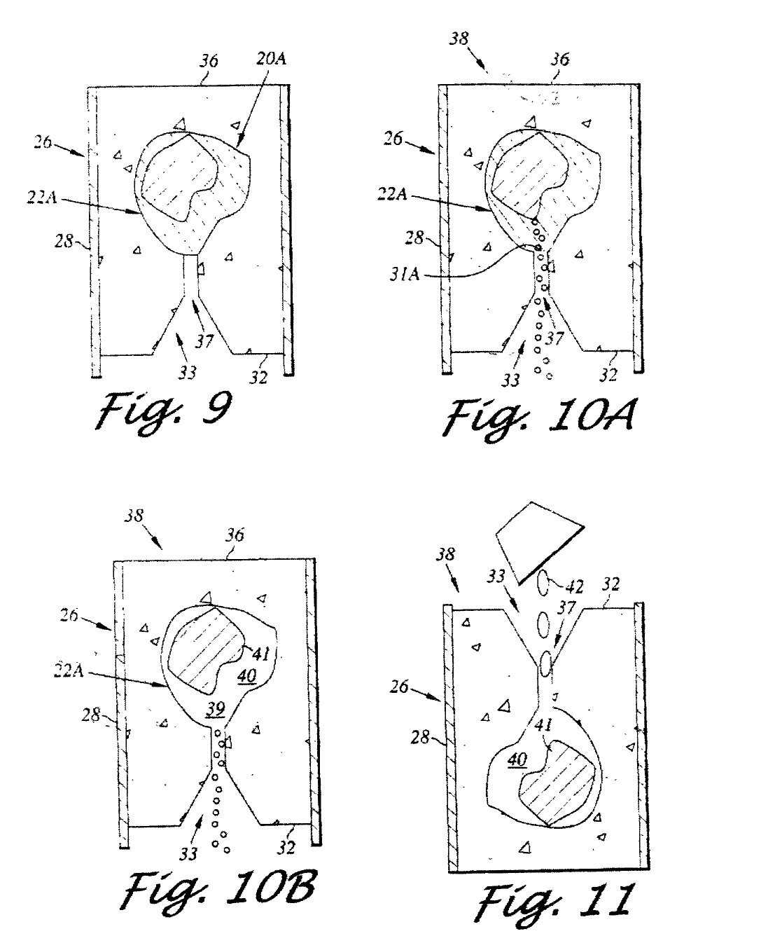

Mold flask 26 containing pattern 20A and semi-liquid plaster 27 is then allowed to stand for a sufficient period of time to allow the plaster to set, i.e., harden into a stone-like mass. Then, as shown in FIG. 9, pattern support member 30 and, optionally, sprue lead 31 are removed from mold flask 26.

Next, as shown in FIG. 10A, mold flask 26 is heated to a temperature high enough to melt and liquify both wax base 21 of pattern 20A, and sprue lead 31, the molten sprue lead material flowing out the mold flask and thereby forming a channel or sprue 37 which allows molten wax from the base to flow from the interior of the pattern, after exiting through hole 31 A in cap 22. This step is performed at a temperature of about 600° F. and may optionally be performed in an inert atmosphere or air, in which latter case some oxidation of wax pattern and/or sprue materials may occur. Next, as shown in FIG. 10B, mold flask 26 is heated to a temperature sufficiently high to melt metal cap 22 of pattern 20A, the molten metal flowing out of the mold flask, metal flowing out of the mold flask through a channel or sprue 37 remaining after sprue lead 31 is removed, thus completing fabrication of an investment casting mold 38 having therewithin a cavity 39 having the desired shape of a gold crown tooth restoration. During this “burn-out” step, which is performed at a temperature of about 1000° F., mold flask 26 preferably is contained within a vacuum chamber or a chamber containing an inert gas, such as argon, nitrogen, or other non-reactive gas, to prevent formation of metal oxide by oxidization of the metal cap 22. The burn-out step results in a cavity 39 be formed in mold 38 which includes an outer concave portion 40 having a shape complementary to the exterior shape of cap 22 of pattern 20A, and a reentrant, convex portion 41 which has a shape complementary to that of the impression formed in base 21 of the core pattern by tooth stump F. Investment casting mold 38 is then used to cast a gold crown restoration, in a conventional manner, as follows.

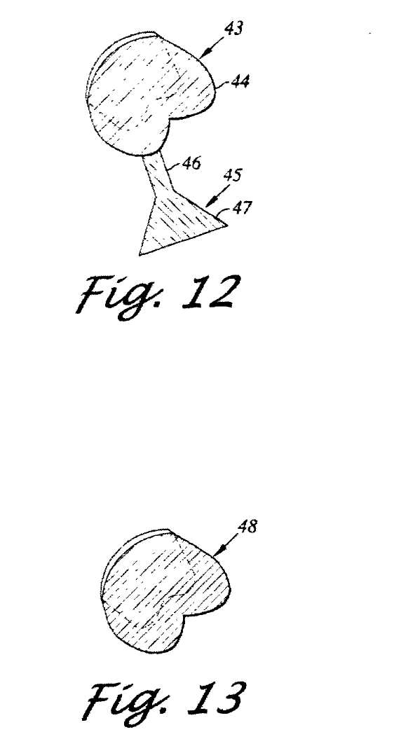

First, mold 38 is rotated from an inverted position, as shown in FIG. 10, to an upright position, as shown in FIG. 11. Next, molten gold alloy 42 is introduced into pouring basin 33 of mold 38, flowing through sprue 37 into mold cavity 39, either under the force of gravity or centrifugal force produced by spinning the mold. Mold 38 is then allowed to cool, causing molten gold alloy 42 within cavity 39 to solidify into a casting 43. Mold 38 is then broken to release casting 43, which, as shown in FIG. 12, includes a portion 44 which is a replica of casting pattern 20A, and an attached button 45 consisting of a cylindrical portion 46 and a conically-shaped portion 47 shaped complementarily to sprue 37 and pouring basin 33, respectively. Button 45 is then cut off of casting 43 to complete fabrication of a finished gold crown casting 48, as shown in FIG. 13.

The novel method of fabricating gold crown castings using the novel pre-contoured impressionable core patterns described above eliminates entirely the step of manually sculpting a wax tooth model to be used as a mold casting pattern, as required by the prior art. Thus, the article and method of the present invention constitute a substantial advancement in the art of dental prostheses fabrication, reducing both time and skill level required.

An important feature of the article and fabrication method according to the present invention is the utilization of a composite pre-contoured impressionable core pattern, consisting of a base made of an impressionable material such as wax, and a pre-shaped cap material made of a shape retaining material such as metal. According to the invention, both the base and cap are made of materials which are evacuable from an investment mold to form a mold cavity. In the example embodiment of the invention described above, evacuation is achieved by melting both the base and cap, and allowing the liquified base and cap materials to flow out from the mold through a sprue. During the burn-out step to remove the metal cap from the cavity, oxidation of the metal cap to metal oxides is to be avoided since the metal oxides will remain in the cavity and will interfere with a successful casting of a crown. Oxidation is prevented by carrying out the burn-out step, especially above 400° F., under a vacuum or in an inert atmosphere, preferably argon. Argon can be bled into a furnace or oven to displace the air during the burn-out step. The burn-out step is carried out above 400° F. in the substantial absence of oxygen.

What is claimed is:

1. A method for fabricating a restoration for an animal tooth comprising the steps of;
a. impressing a stump portion of a tooth to be fitted with a restoration into an impressionable base portion of a pattern pre-form having a shape-retaining cap portion which has an exterior shape and size which replicates that of desired finished restoration, said impressing converting said pre-form into a pattern,
b. withdrawing said pattern from said stump portion of tooth,
c. investing said pattern into semi-liquid casting mold material,
d. allowing said mold material to solidify into a mold,
e. subjecting said mold material to a stimulus which causes said base portion of said pattern to change from a solid phase to a phase evacuable from said mold material, thereby forming within said mold a cavity core portion replicating the shape of said tooth stump,
f. subjecting said mold material to a stimulus in the absence of oxygen which causes said cap portion of said pattern to change phase from a solid phase to a phase evacuable from said mold material, thereby forming within said mold a hollow cavity portion having a surface replicating said exterior shape of said cap,
g. evacuating said non-solid phases of said base and said cap from said mold,
h. pouring liquid restoration casting material into said mold cavity,
i. allowing said liquid casting material to solidify into a cast restoration within said mold cavity, and
j. removing said casting restoration from said mold.

2. The method of claim 1 wherein said phase of said base evacuable from said mold material is a liquid.

3. The method of claim 2 wherein said stimulus is further defined as heat sufficient to melt said base.

4. The method of claim 3 wherein said second phase of said cap evacuable from said mold material is a liquid.

5. The method of claim 4 wherein said stimulus is further defined as heat sufficient to melt said cap.

6. The method of claim 3 wherein said second phase of said cap evacuable from said mold material is a gas.

7. The method of claim 6 wherein said second stimulus is heat sufficient to convert said solid cap to a gas.

8. The method of claim 1 wherein said base portion of said pattern pre-form is further defined as including a polymer.

9. The method of claim 8 wherein said polymer is further defined as being a wax.

10. The method of claim 8 wherein said cap is further defined as being made of a metal.

11. The method of claim 10 wherein said metal is further defined as including tin.

12. A method for fabricating a restoration for an animal tooth comprising the steps of;
a. impressing a stump portion of a tooth to be fitted with a restoration into an impressionable base of a pattern pre-form including a base and cap which surmounts said base, said base being made of a material adapted to receive and retain an impression of a tooth stump, and meltable at a pre-determined base-melting temperature range, said cap be made of shape-retaining material having a shape which replicates that of a desired finished tooth restoration, and meltable at a pre-determined cap-melting temperature, said impressing of said base with said tooth stump converting said pre-form into a pattern,
b. withdrawing said pattern from said stump portion of said tooth,
c. investing said pattern into a semi-liquid casting mold material,
d. allowing said mold material to solidify into a mold,
e. elevating temperature of said mold to a temperature sufficient to melt said base into a liquid,
f. elevating temperature of said mold to a temperature sufficient to melt said cap into a liquid,
g. pouring said liquid base material from said mold,
h. pouring said liquid cap material from said mold,
i. pouring liquid casting material into a cavity formed within said mold by removal therefrom of said liquid base material and said liquid cap material,
j. allowing said liquid casting material to solidify within said mold cavity to form therewithin a cast restoration, and
k. removing said cast restoration from said mold.

13. The method of claim 12 wherein said base material is further defined as being a wax.

14. The method of claim 13 wherein said cap is further defined as being made of a metal.

15. The method of claim 14 wherein said metal is further defined as including tin.

16. A pre-form for fabricating a mold pattern used in casting an animal tooth restoration, said pre-form comprising;
a. a base composed of a material adapted to receive and retain an impression of a tooth stump, and
b. a cap surmounting said base, said cap being made of a shape-retaining material having an external shape and size replicating that of a desired restoration.

17. The pre-form of claim 16 wherein said base material is further defined as being a meltable material.

18. The pre-form of claim 17 wherein said meltable material is further defined as being a polymer.

19. The pre-form of claim 17 wherein said meltable material is further defined as being a wax.

20. The pre-form of claim 19 wherein said cap is further defined as being made of a meltable material.

21. The pre-form of claim 20 wherein said meltable material is further defined as being a metal.

22. The pre-form of claim 21 wherein said base material is further defined as being a meltable material.

23. The pre-form of claim 21 wherein said meltable material is further defined as being a polymer.

24. The preform of claim 22 wherein said meltable material is further defined as being a wax.
